(19) United States
(12) Patent Application Publication
(10) Pub. No.: US 2026/0255136 A1
(43) Pub. Date: Aug. 27, 2026

(54) Method of, and System for, Performing Identity Association

(71) Applicant: MIX TELEMATICS INTERNATIONAL (PROPRIETARY) LIMITED, cape Town (ZA)

(72) Inventors: Jonathan Makepeace, Cape Town (ZA); Rohan Combrinck, Cape Town (ZA)

(21) Appl. No.: 18/854,494

(22) PCT Filed: Apr. 6, 2023
(86) PCT No.: PCT/IB2023/053527

§ 371 Date: Oct. 4, 2024

(30) Foreign Application Priority Data
Apr. 7, 2022 (GB) 2205142.9

(51) Int. Cl. H04W 4/30

(52) U.S. Cl. CPC H04W 4/30

(57) ABSTRACT

A system for, and method of, performing identity association between subjects and systems. A communication module of the system receives wireless signals from two or more mobile communication devices of subjects. An association module of the system identifies a specific mobile communication device from the two mobile communication devices based on one or more criterion/criteria, and transmits data to the identified mobile communication device. The data includes a unique identifier for the system (“system unique identifier”). The association module also receives a message from the identified mobile communication device which includes a unique identifier for the identified mobile communication device, and an identifier which identifies a specific system. The association module then compares the received identifier which identifies a specific system with the system unique identifier, and if they match, to associate the subject, with which the identified mobile communication device is associated, with the system.

### BACKGROUND OF THE INVENTION

THIS invention relates to a method of, and system for, performing identity association.

Identity association refers to the association of a subject's unique identity with another agent under desired conditions, for the purpose of linking the agent and subject to enable some use case. The subject can be human or non-human, such as an animal, machine or other. The agent could be another subject, object or system and can be associated with a particular property, such as a building, room, vehicle, place, machine, device or other. Any relevant function or use case can be linked between the agent and subject under the identity association. Identity association can also be done between any number of agents and subjects.

There are several existing structures used to perform identity association including (but not limited to): mechanical connections between an identification device held by a subject and a physical receptacle device, short-range wireless connection between a device held by the subject and a wireless receptacle, and biometric systems where a biometric property of the subject is presented to a biometric capture device.

The existing methods are however not satisfactory and convenient for all applications of an identification system, as they require a receptacle or extension device that is located at the exact physical point of identification. For example, to be robust, an identification system that associates a driver with a vehicle by means of an electrically connected or near-field wireless device would require that the receptacle of the device be installed in the vehicle dashboard, which may cause damage to the vehicle which in turn affects the resale value of the vehicle. The receptacle device is also purpose specific, so the electronic hardware cannot be used for other purposes, such as for communicating other data over various ranges. These devices are often installed as an additional component to the system, which also brings an increased installation and maintenance burden and reduced reliability.

Another issue which the Inventors have identified is when numerous cars are parked next to each other and a number of people with electronic devices try and associate their specific electronic device with a particular car at the same time, since all the cars might essentially be bombarded with signals/messages from various electronic devices. In other to make the correct association is difficult in such a situation, since merely associating a particular car (“first car”) with its closest electronic device might not be correct. The reason for this is that the person handling the electronic device might actually be sitting in another car (“second car”) parked right next to the first car. In such a situation, the person handling the electronic device should be associated with the second car and not the first car. However, the Inventors have found that current technologies cannot address this issue.

There is therefore a need for identity association between subjects, subjects and objects, or subjects and systems for various purposes, including but not limited to: authentication between these agents for the purpose of enabling state change functions on and by either of the agent, e.g. access control, linking data between agents for the purpose of tracking or behaviour monitoring and enforcement, and other electronic business purposes.

The Inventors wish to alleviate at least some of the problems mentioned above.

### SUMMARY OF THE INVENTION

In accordance with a first aspect of the invention there is provided a method of performing identity association between a subject and a system, wherein the method includes:
at the system, receiving data via wireless signals from two or more mobile communication devices, wherein each mobile communication device is associated with a specific subject;
at the system, identifying, by using a processor, a specific mobile communication device from the two or more mobile communication devices based on one or more criterion/criteria;
from the system, transmitting data, via wireless communication, to the identified mobile communication device, wherein the data includes a unique identifier for the system (hereinafter referred to as the “system unique identifier”);
at the system, receiving a message from the identified mobile communication device, via wireless communication, wherein the message includes
   a unique identifier for the identified mobile communication device, and
   an identifier which identifies a specific system;
   at the system, comparing, by using a processor, the received identifier which identifies a specific system with the system unique identifier, and if they match, associating the subject, with which the identified mobile communication device is associated, with the system

The association is therefore effectively done through a bi-directional data exchange between the system and the two or more mobile communication devices which are associated with the respective subjects.

It should be clear that the term “mobile communication device” should be interpreted to not only include mobile phones, but other types of mobile communication devices as well, such as remotes and smart keys (e.g. vehicle smart keys/fobs) which can communicate wirelessly.

The term “bi-directional data exchange” in this context refers to the (i) receiving of data (“received data”) from the two or more mobile communication devices and (ii) the transmission of data to the two or more mobile communication devices.

The term “subject” should be interpreted to include an agent, person, animal or thing (e.g. a physical article/device).

The term “system” should be interpreted to also include a device, an apparatus or a subject.

The one or more criterion/criteria for identifying the specific mobile communication device from the two or more mobile communication devices may include only taking into account mobile communication devices who's data has been received within a specified/pre-determined time frame or time window.

The time frame or time window may run from when the system first receives data via a wireless signal from a first of the two or more communication devices.

The method may include enabling one or more functions to be performed by a subject which has been associated with the system, wherein the one or more functions would otherwise not be permitted if the subject was not associated with the system.

The one or more criterion/criteria for identifying the specific mobile communication device from the two or more mobile communication devices may include taking into account a relative proximity between the system and each of the two or more mobile communication devices with which the respective subjects are associated.

The method may include determining or obtaining, by using a processor, an indication of an approximate distance between the system and each mobile communication device, by utilising a signal strength of the received signal from each mobile communication device. The one or more criterion/criteria for identifying the specific mobile communication device from the two or more mobile communication may include determining/identifying the mobile communication device which is the closest to the system.

The method may include sending, from the system, (i) an indication of the approximate distance determined between the system and the closest mobile communication device, and (ii) the system unique identifier for the system, back to the identified mobile communication device which is closest to the system, via wireless communication.

The data received from each mobile communication device may include any one or more of the following:
a relative heading/direction and speed of travel of the particular mobile communication device;
a relative acceleration of the particular mobile communication device;
a relative position of the particular mobile communication device;
a temperature associated with the particular mobile communication device; and
a humidity associated with the particular mobile communication device.

In accordance with a second aspect of the invention there is provided a method of performing identity association between a subject and a system, wherein the method includes:
at the system, receiving data via wireless signals from two or more mobile communication devices, wherein each mobile communication device is associated with a specific subject;
transmitting data, via wireless communication, to the two or more mobile communication devices;
determining/identifying which one of the subjects should be associated with the system, based on a wireless, bi-directional data exchange between the system and the two or more mobile communication devices which are associated with the respective subjects.

The step of receiving data via wireless signals from two or more mobile communication devices may include receiving the data via wireless signals from the two or more mobile communication devices within a specified/pre-determined time frame or time window.

The step of determining/identifying which one of the mobile communication devices should be associated with the system may include only taking into account mobile communication devices who's data has been received within the time frame or time window.

The time frame or time window may run from when the system first receives data via a wireless signal from a first of the two or more communication devices.

The method may include enabling one or more functions to be performed by a subject which has been associated with the system, wherein the one or more functions would otherwise not be permitted if the subject was not associated with the system.

The step of determining/identifying which one of the subjects should be associated with the system may include taking into account a relative proximity between the system and each of the two or more mobile communication devices with which the respective subjects are associated.

The method may include determining or obtaining, by using a processor, an indication of an approximate distance between the system and each mobile communication device, by utilising a signal strength of the received signal from each mobile communication device.

The step of determining/identifying which one of the subjects should be associated with the system may include determining/identifying the mobile communication device which is the closest to the system.

The method may include sending, from the system, (i) an indication of the approximate distance determined between the system and the closest mobile communication device, and (ii) a unique identifier which identifies the particular system, back to the determined/identified mobile communication device which is closest to the system, via wireless communication.

The method may include, after sending the indication and unique identifier to the determined/identified mobile communication device which is closest to the system, receiving from the said determined/identified mobile communication device, via wireless communication,
an identifier which identifies a specific system with which the subject is to be associated, and
a subject identifier which identifies the specific subject.

The method may further include associating the subject with the system only if the identifier sent from the system to the determined/identified mobile communication device matches the identifier received from the determined/identified mobile communication device.

The data received from each mobile communication device may include any data that could be used to make an identity association on the condition of relative states.

More specifically, the data received from each mobile communication device may include any one or more of the following:
a relative heading/direction and speed of travel of the particular mobile communication device (e.g. in relation to the system);
a relative acceleration of the particular mobile communication device (e.g. in relation to the system);
a relative position of the particular mobile communication device (e.g. in relation to the system);
a temperature associated with the particular mobile communication device (e.g. an ambient temperature of the location of the mobile communication device); and
a humidity associated with the particular mobile communication device (e.g. a humidity of the location of the mobile communication device).

In accordance with a third aspect of the invention there is provided a system for performing identity association with a subject, wherein the system includes:
a communication module which is configured to receive wireless signals which are transmitted from two or more mobile communication devices, wherein each mobile communication device is associated with a particular subject; and
an association module which is configured to
   identify a specific mobile communication device from the two or more mobile communication devices based on one or more criterion/criteria
   transmit data, via wireless communication, to the identified mobile communication device, wherein the data includes a unique identifier for the system (hereinafter referred to as the “system unique identifier”);
   receive a message from the identified mobile communication device, via wireless communication, wherein the message includes
      a unique identifier for the identified mobile communication device, and
      an identifier which identifies a specific system;
   compare the received identifier which identifies a specific system with the system unique identifier, and if they match, associating the subject, with which the identified mobile communication device is associated, with the system.

A “module”, in the context of the specification, includes an identifiable portion of code, computational or executable instructions, or a computational object to achieve a particular function, operation, processing, or procedure. A module may be implemented in software, hardware or a combination of software and hardware. Furthermore, modules need not necessarily be consolidated into one device.

The one or more criterion/criteria for identifying the specific mobile communication device from the two or more mobile communication devices may include only taking into account mobile communication devices whose data has been received within a specified/pre-determined time frame or time window.

The time frame or time window may run from when the communication module first receives data via a wireless signal from a first of the two or more communication devices.

The association module may be configured to enable one or more functions to be performed by a subject which is associated with the system, whereby the one or more functions would otherwise not be permitted if the subject was not associated with the system.

The one or more criterion/criteria for identifying the specific mobile communication device from the two or more mobile communication devices may include taking into account a relative proximity between the system and each of the two or more mobile communication devices, in order to determine which subject should be associated with the system.

The system may include a calculation module which is configured to determine or obtain an indication of an approximate distance between the system and each mobile communication device, by utilising a signal strength of the received signal from each mobile communication device. The one or more criterion/criteria for identifying the specific mobile communication device from the two or more mobile communication devices may include identifying the mobile communication device which is the closest to the system.

The two or more mobile communication devices may form part of the system.

The data received from each mobile communication device may include any one or more of the following:
a relative heading/direction and speed of travel of the particular mobile communication device;
a relative acceleration of the particular mobile communication device;
a relative position of the particular mobile communication device;
a temperature associated with the particular mobile communication device; and
a humidity associated with the particular mobile communication device.

In accordance with a fourth aspect of the invention there is provided a method of performing identity association between a subject and a system, wherein the method includes:
from a mobile communication device of the subject, transmitting a wireless signal which includes an identifier which identifies the specific subject or mobile communication device (hereinafter referred to as the “device identifier”);
receiving, via wireless communication at the mobile communication device, a message from each of a plurality of systems, wherein each message includes
   an identifier which identifies the particular system (hereinafter referred to as the “system identifier”),
   an identifier which identifies a specific subject or mobile communication device (hereinafter referred to as the “first identifier”), and
   additional data,
for each of the plurality of systems, identifying if the first identifier included in the received message from the specific system matches the device identifier of the specific subject/mobile communication device,
identifying a specific system, from those systems whose message included a first identifier which matched the device identifier of the specific subject/mobile communication device, with which the subject should be associated, based on one or more criterion/criteria

The method may include transmitting, via wireless communication from the mobile communication device, a message which includes the system identifier of the system with which the subject should be associated.

The additional data may include an indication of the approximate distance between the particular system and the mobile communication device.

The one or more criterion/criteria may include identifying which specific system, from those systems whose message included a first identifier which matched the device identifier of the specific subject/mobile communication device, is the nearest to the mobile communication device, by utilising the indications of the approximate distances between the mobile communication device and each of the said systems, and selecting the identified system to be associated with the subject. The method may include transmitting, via wireless communication from the mobile communication device, a message which includes the system identifier of the system with which the subject should be associated.

The additional data may include any one or more of the following:
a relative heading/direction and speed of travel of the particular system;
a relative acceleration of the particular system;
a relative position of the particular system;
a temperature associated with the particular system;
a humidity associated with the particular system.

In accordance with a fifth aspect of the invention there is provided a mobile communication device on which a set of instructions are stored which, when executed by a processor of the device, performs method in accordance with the first, second or fourth aspects of the invention.

In accordance with a sixth aspect of the invention there is provided a system for performing identity association with a subject, wherein the system includes:
a communication module which is configured to receive wireless signals which are transmitted from two or more mobile communication devices, wherein each mobile communication device is associated with a particular subject; and
an association module which is configured to determine/identify which one of the subjects should be associated with the system, based on a bi-directional data exchange between the system and the two or more mobile communication devices of the subjects.

The association module may be configured to only take into account mobile communication devices whose data has been received within a specified/pre-determined time frame or time window.

The time frame or time window may run from when the communication module first receives data via a wireless signal from a first of the two or more communication devices.

The association module may be configured to enable one or more functions to be performed by a subject which is associated with the system, whereby the one or more functions would otherwise not be permitted if the subject was not associated with the system.

The association module may be configured to take into account a relative proximity between the system and each of the two or more mobile communication devices, in order to determine which subject should be associated with the system.

The system may include a calculation module which is configured to determine or obtain an indication of an approximate distance between the system and each mobile communication device, by utilising a signal strength of the received signal from each mobile communication device. The association module may be configured to determine/identify the mobile communication device which is the closest to the system. The communication module may be configured to
send an indication of the approximate distance determined and a unique identifier which identifies the particular system back to the determined/identified mobile communication device via wireless communication,
after sending the indication and unique identifier to the determined/identified mobile communication device of the subject, receive from the determined/identified mobile communication device, via wireless communication, (i) an identifier which identifies a specific system with which the subject, which is associated with the determined/identified mobile communication device, is to be associated, and (ii) a subject identifier which identifies the specific subject,
associate the particular subject with the system only if the identifier sent from the system to the determined/identified mobile communication device of the subject matches the identifier received from the determined/identified mobile communication device.

The two or more mobile communication devices may form part of the system.

The data received from each mobile communication device may include any data that could be used to make an identity association on the condition of relative states.

More specifically, the data received from each mobile communication device may include any one or more of the following:
a relative heading/direction and speed of travel of the particular mobile communication device (e.g. in relation to the system);
a relative acceleration of the particular mobile communication device (e.g. in relation to the system);
a relative position of the particular mobile communication device (e.g. in relation to the system);
a temperature associated with the particular mobile communication device (e.g. an ambient temperature of the location of the mobile communication device); and
a humidity associated with the particular mobile communication device (e.g. a humidity of the location of the mobile communication device).

In accordance with a seventh aspect of the invention there is provided a method of performing identity association between a subject and a system, wherein the method includes:
from a mobile communication device of the subject, transmitting a wireless signal;
receiving, via wireless communication at the mobile communication device, a message from each of a plurality of systems, wherein each message includes
   an identifier which identifies the particular system, and additional data;
determining, at the mobile communication device, which system of the plurality of systems should be associated with the particular subject based on a bi-directional data exchange between the systems and the mobile communication device; and
transmitting, via wireless communication from the mobile communication device, a message which includes the identifier of the particular system which should be associated with the subject.

The additional data may include an indication of the approximate distance between the particular system and the mobile communication device.

The method may include:
determining which system of the plurality of systems is the nearest to the mobile communication device, by utilising the indications of the approximate distances between the mobile communication device and each of the systems, and selecting the determined system to be associated with the subject, and
transmitting, via wireless communication from the mobile communication device, a message which includes the identifier of the system with which the subject should be associated.

The additional data may include any data that could be used to make an identity association on the condition of relative states.

More specifically, the additional data may include any one or more of the following:
a relative heading/direction and speed of travel of the particular system (e.g. in relation to the mobile communication device);
a relative acceleration of the particular system (e.g. in relation to the mobile communication device);
a relative position of the particular system (e.g. in relation to the mobile communication device);
a temperature associated with the particular system (e.g. an ambient temperature of the location of the system);
a humidity associated with the particular system (e.g. a humidity of the location of the system).

In accordance with an eighth aspect of the invention there is provided a mobile communication device on which a set of instructions are stored which, when executed by a processor of the device, performs the following steps:
receiving, by utilising a communication module of the device, data via wireless signals from two or more mobile communication devices, wherein each mobile communication device is associated with a specific subject;
transmitting data, via wireless communication, to the two or more mobile communication devices, by utilising a communication module;
determining/identifying which one of the mobile communication devices should be associated with the system, based on a bi-directional data exchange between the system and the two or more mobile communication devices.

In accordance with a ninth aspect of the invention there is provided a computer program which is executable by a processor of a mobile communication device and which is configured, when executed, to perform the following steps:
receiving, by utilising a communication module of the device, data via wireless signals from two or more mobile communication devices, wherein each mobile communication device is associated with a specific subject;
transmitting data, via wireless communication, to the two or more mobile communication devices, by utilising a communication module;
determining/identifying which one of the mobile communication devices should be associated with the system, based on a bi-directional data exchange between the system and the two or more mobile communication devices.

In accordance with a tenth aspect of the invention there is provided a non-transitory computer readable storage medium on which the computer program in accordance with the ninth aspect of the invention is stored.

In accordance with an eleventh aspect of the invention there is provided a non-transitory computer readable storage medium on which a set of instructions are stored which, when executed, performs the method in accordance with the the first, second or fourth aspects of the invention.

In accordance with a twelfth aspect of the invention there is provided a method of performing identity association between multiple subjects which each have a mobile communication device and multiple systems, wherein the method includes:
at each system, receiving data via wireless signals from two or more mobile communication devices, wherein each mobile communication device is associated with a specific subject, and wherein the data from each mobile communication device includes at least an identifier (hereinafter referred to as the “device identifier”) which identifies the particular mobile communication device;
at each system, identifying, by using a processor, a specific mobile communication device from the two or more mobile communication devices based on one or more criterion/criteria;
from each system, transmitting data via a wireless signal(s), wherein the data includes a unique identifier for the system (hereinafter referred to as the “system unique identifier”) and the device identifier of the mobile communication device identified by the particular system;
at each mobile communication device:
   receiving, via wireless communication, data from each of a plurality of systems, wherein the data includes
      an identifier which identifies the particular system,
      an identifier (hereinafter referred to as the “first identifier”) which identifies a specific mobile communication device, and
      additional data,
   for each of the plurality of systems, identifying if the first identifier included in the received data from the specific system, matches the device identifier of the specific mobile communication device,
   identifying one specific system, from those systems whose data included a first identifier which matched the device identifier of the specific mobile communication device, with which the subject should be associated, based on one or more criterion/criteria.

The method may include implementing the method in accordance with the first or second aspects of the invention on each of the systems. The method may include implementing the method in accordance with the fourth aspect of the invention on each of the mobile communication devices.

In accordance with a thirteenth aspect of the invention there is provided a method of performing identity association between multiple subjects which each have a mobile communication device and multiple systems, wherein the method includes:
on/at each of the systems, implementing the method in accordance with the first or second aspects of the invention; and
on/at each of the mobile communication devices, implementing the method in accordance with the fourth aspects of the invention.

In accordance with a fourteenth aspect of the invention there is provided a system/platform/arrangement for performing identity association between multiple systems and multiple mobile communication devices, wherein each mobile communication device is associated with a specific subject, wherein the system includes:
a plurality of systems which are each in accordance with the third or sixth aspects of the invention; and
a plurality of mobile communication devices which are each in accordance with the fifth or eighth aspects of the invention.

### BRIEF DESCRIPTION OF THE DRAWINGS

The invention will now be described, by way of example, with reference to the accompanying diagrammatic drawings. In the drawings

FIG. 1 shows a schematic diagram of the operation of the present invention in accordance with invention;

FIG. 2 shows a schematic layout of a process flow of the system shown in FIG. 1;

FIG. 3 shows a schematic view of when two people are in two separate vehicles which are located next to each other, and both people try and form an association with a system which is installed in their particular vehicle, by using a mobile communication device (e.g. a remote);

FIG. 4 shows a flow diagram which illustrates the operation of the system in accordance with the invention;

FIG. 5a shows a flow diagram which illustrates the operation of a system, in the form of a vehicle mobile base station, which forms part of the system in accordance with the invention;

FIG. 5b shows a flow diagram which illustrates the operation of a mobile communication device in the form of a remote, which is utilised by a driver and which forms part of the system in accordance with the invention; and

FIG. 5c shows a functional layout of a system (e.g. a vehicle mobile base station) in accordance with the invention.

### DESCRIPTION OF PREFERRED EMBODIMENTS

Identity association for the purposes of access control, behaviour tracking, electronic business purposes or others, is normally achieved by mechanical reference or near-field wireless means (refer to RFID, tag, card, dongle, biometric and other). As mentioned, identity association relates to the association of a subject's particular identity with an identifying system under desired conditions for a desired period, for some useful purpose. Any data can be linked between the subject and system under the association.

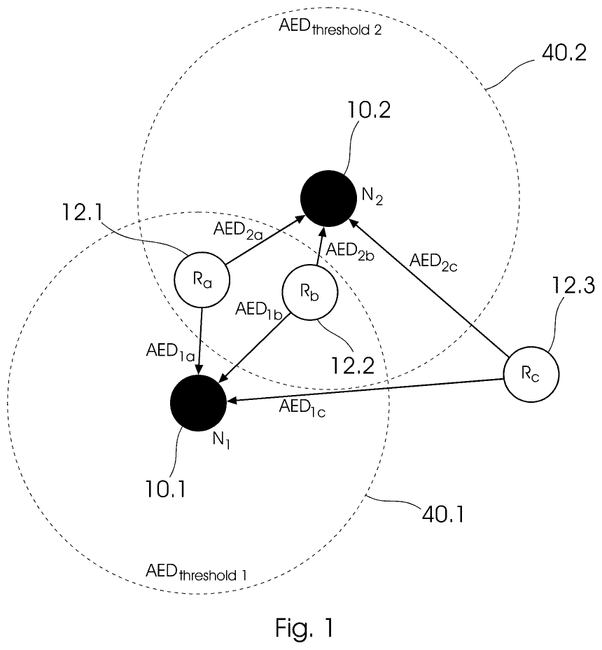

For identity association, the present invention utilises bi-directional wireless technology (such as Bluetooth, NFC, Wi-Fi, Zigbee, Z-wave, 6LoWPAN, LoRa, cellular and other). The present invention uses received signal strength/received signal strength index (RSSI) to calculate the approximate effective distance (AED) of subject devices (e.g. remotes-R) in range of identifying systems (e.g. nodes-N) to determine which valid identity associations can be made under a set of desired conditions i.e., maximum AED, AED below threshold, etc. For additional accuracy in calculating the AED, the radiated power (TX power) at which a subject device transmits a signal can also be used. Other RF principles and localisation technologies could also be applied to improve the reliability of the AED. Instead of using AED, other data could also be used instead in order to determine which identity association should be made, such as GNSS coordinates of the respective devices and systems, where the associating data is that one device and one system are at a same or similar geographical point. Another example is speed and relative heading of the respective devices and systems, where the associating data is that one device and one system are moving at the same speed and relative heading. The present invention typically includes one or more systems 10.1, 10.2 (collectively hereinafter referred to as the “systems 10”) with which subjects (e.g. users) can make associations with, by utilising their own mobile communication device 12.1, 12.2, 12.3 (collectively hereinafter referred to as the “mobile communication devices 12”). The systems 10 may, for example, be in the form of base stations or nodes N1, N2 (see FIG. 1). It should however be appreciated that the systems 10 may also be mobile communication devices of other subjects, machines, or devices.

The mobile communication devices 12 may, for example, be in the form of remotes Ra, Rb, Rc (see FIG. 1). However, it should be appreciated that the mobile communication devices could also, for example, be smart devices, such as smart phones.

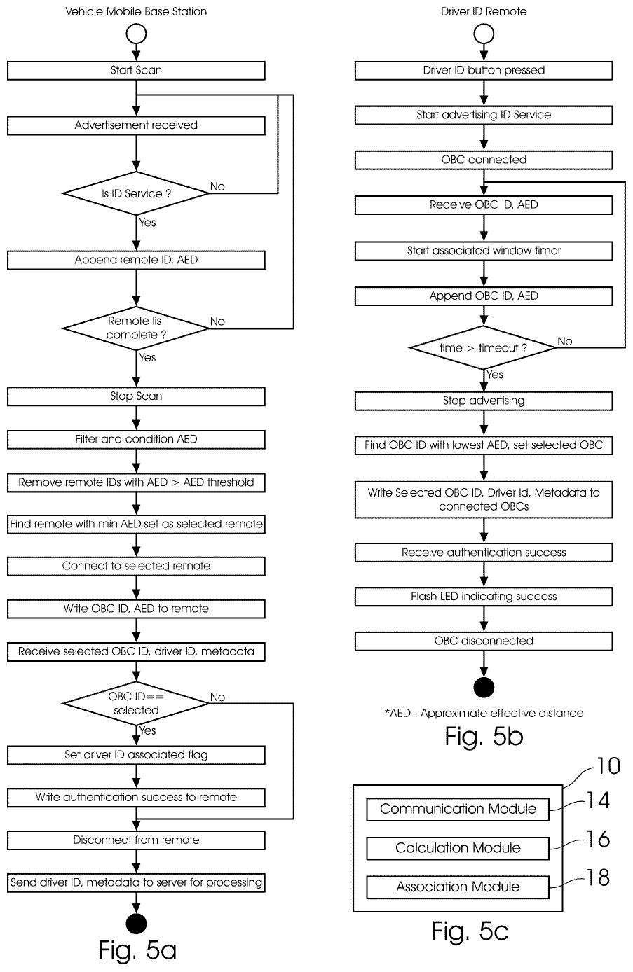

Each node N₁, N₂ includes a communication module 14, a calculation module 16 and an association module 18 (see FIG. 5c).

Each node N₁, N₂ may be calibrated for a specific AED threshold (e.g. a maximum distance). However, the nodes N₁, N₂ can also be uncalibrated.

Each remote Rₐ-R_{c} may be calibrated to transmit a signal at a specified power level (TX). However, the remotes Rₐ-R_{c} can also be uncalibrated.

In order to initiate the association process, a subject can perform an initiation action, for example by pressing a button on his/her remote Rₐ-R_{c}. However, it should be noted that the association process can also be initiated automatically without a subject needing to perform a specific action (e.g. the remote Rₐ-R_{c} may send out signals periodically in order to initiate an association process when in range of a particular system 10).

In one example, the remote Ra transmits a wireless signal which includes a unique subject identifier which identifies the particular remote Ra. Optionally, the transmitted signal may be accompanied by (i) an indication of a transmission power value at which the signal is transmitted (e.g. the signal may contain a message which indicates that the signal was transmitted at XX mW) and/or (ii) a pre-calibrated transmission power value at a known fixed distance of the remote's radio frequency (RF) system/module, in order to help increase reliability. Other desired data may also accompany the transmitted signal.

If a particular node N₁ is in range and receives the transmitted signal (e.g. via the communication module 14 of the node N₁), then its calculation module 16 calculates its approximate effective distance (AED) as a function of (i.e. by utilising) the received signal strength/signal strength index (RSSI) of the transmitted signal and, optionally, the transmitted power which may accompany the transmitted signal. The AED therefore indicates the effective separation/distance between the node N1 and the remote Rₐ.

Once the AED has been calculated, the association module 18 of the node N₁ determines if the particular remote Rₐ is allowed to be associated with the node N₁, based on one or more conditions. One of these conditions may be whether the AED exceeds a pre-determined maximum allowable distance (see the maximum AED thresholds 40.1, 40.2 illustrated in FIG. 1). Another condition that should be met (in addition to not exceeding the maximum allowable distance) may, for example, be that the AED for the remote Ra should be the lowest, when compared to AED's calculated for signals received from other nodes (e.g. remotes R_{b} and R_{c}). In other words, the remote Rₐ which is closest to the node N₁ should be selected/prioritised over the remotes (R_{b} and R_{c}) further away, for identity association purposes.

If the AED of a particular remote Ra satisfies the conditions mentioned above, then the remote Rₐ is validated by the node N₁. Once validated, the node N₁ establishes a one to one wireless connection with the particular remote Rₐ by means of the remote's unique identifier and transmits the AED calculated for the particular remote Rₐ, together with a unique identifier which identifies the particular node N₁ to the remote Rₐ via wireless communication. Additional desired data may also be sent together with the unique identifier and the AED.

It should be noted that if other nodes N₂, N₃ are also in range of the signal transmitted by the remote Rₐ, then they will also implement the same process described above.

The remote Rₐ will typically then receive messages from a plurality of nodes N₁-N₃ which are in range (with each message including the AED and unique identifier for the particular node). The remote Rₐ is accordingly configured (e.g. by way of software) to provide a time window/frame within which the remote Rₐ receives and analyses messages received from the nodes N₁-N₃. The time window typically runs for a period of time immediately after the remote Rₐ has sent the initial signal. If, for example, a message from a node is received outside of the time window, then it will not be analysed/taken into account.

After the remote Rₐ has received messages from a plurality of nodes N₁-N₃ within the time window, the remote Rₐ selects the node with the lowest AED (i.e. the node N₁ closest to the remote Rₐ) as the valid node for the remote Rₐ.

The remote Ra then transmits the unique identifier of the valid node N₁, the unique subject identifier which identifies the particular remote Ra and other desired data (if any) via wireless communication.

The nodes N₁-N₃ then receives the transmission. The association module 18 of each node N₁-N₃ then compares the received unique identifier of the valid node with its own unique identifier. If they match, then the association module 18 forms an association between the remote Rₐ and the particular node N₁. If the identifiers however do not match, then no association is formed.

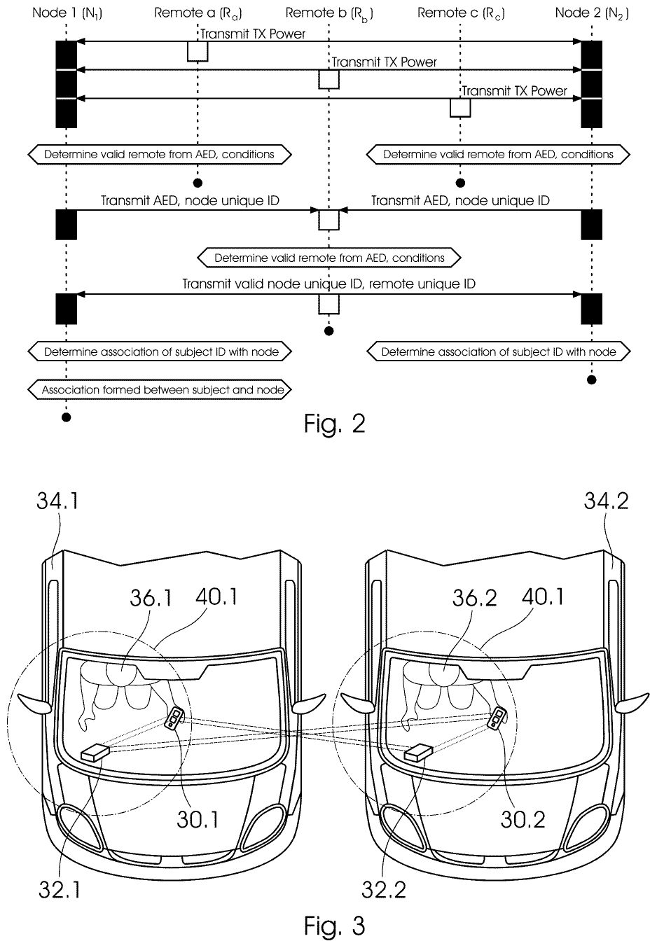

The particular process described above is also illustrated in FIG. 2.

### Practical Example

In this example, the identity association is applied in the field of driver identification for vehicles which are used as part of a fleet management system, for the purposes of (i) incident tracking (in the case of providing evidence for insurance claims), (ii) access control in which drivers are only permitted to drive specific vehicles, and (iii) driver behaviour monitoring to improve safety. Reference is in this regard specifically made to FIG. 3.

More specifically, in this example, the purpose of the driver identity association with the vehicle could be to:
(a) allow or disallow the driver to operate the vehicle, depending on whether they are permitted to do so,
(b) record events related to the driver's operation of the vehicle during the period of operation, such as excessive engine speed, vehicle speed, acceleration, deceleration, cornering forces, etc.,
(c) track metrics associated with the driver's operation of the vehicle, such as fuel consumption, and/or
(d) record and report on data in the case of an accident.

In this example, wireless communication technology (such as Bluetooth Low Energy) is again used as the means of communication, in order to enable the identity association between a driver and a vehicle by using the process described earlier above.

The fleet management system typically includes drivers, vehicles, remotes, and mobile base stations. Each driver is allocated a remote 30.1, 30.2 (collectively hereinafter referred to as “remotes 30”). The remotes 30 are battery-operated wireless devices with unique remote identifiers, identification buttons, and status indicating LED's. The unique remote identifier is linked to a specific driver profile on the fleet management software. A mobile base station 32.1, 32.2 (collectively hereinafter referred to as “base stations 32”) is installed in each vehicle 34.1, 34.2 (collectively hereinafter referred to as the “vehicles 34”) near the driving position. The mobile base stations 32 are devices that support wireless communication with the remotes 30 and are connected to the internet via a mobile data connection. The mobile base stations 32 are linked to the vehicle profile on the fleet management software and are used for tracking vehicle location and activity.

The conditions of the identity association in this example are:
(i) the least distance between one of many remote devices 30 and a specific base station 32,
(ii) the least distance between one of many base stations 32 and a specific remote device 30, and
(iii) a distance value between a remote 30 and base station 32 being below a maximum distance threshold (e.g. of 1 meter—see reference numerals 40.1, 40.2 which illustrates this range), which composes/includes the range of the driving position.

When the driver 36.1, 36.2 (collectively hereinafter referred to as “driver 36”) wants to associate himself/herself with a particular vehicle 34 in order to allow him/her to operate the vehicle 34, the driver 36 should ensure that he/she is positioned in the driving seat of the vehicle 34 and then press the identification button on the remote 30 to signal the intention to make the identity association.

It should be noted that there may be more than one remote device 30 trying to make an identity association at the same time. For example, let's assume that two drivers 36 are located at the driving position of two different vehicles 34 respectively, which are parked right next to each other (as shown in FIG. 3). Both drivers 36 then press the identification buttons of their associated remotes 30 at the same time.

Each remote 30 then transmits a message to all nearby mobile base station devices containing the remote's unique remote identifier (e.g. the mobile base stations 32 installed in the respective vehicles 34), a pre-calibrated transmission power of the remote 30 at a fixed distance and a current transmission power of the remote 30. Each remote can typically be a BLE (Bluetooth Low Energy) device. The message can typically include a service identifier of the remote 30.

The base stations 32 receive the messages from the remotes 30 and, for each remote, calculates the approximate effective distance (AED) between the base station 32 and the remote 30 using the received signal strength index (RSSI) and the transmission power values received, using well-established RF relationships. This type of calculation is well known in the field and will therefore not be described in more detail. If the AED for a particular remote 30 is below the maximum threshold and is the least distance between the base station and all remotes 30, the base station selects the remote 30 as an identifying remote 30. In this case, there can be multiple base stations 32 that select the same remote 30 if there are multiple base stations 32 meeting the conditions.

The base stations 32 then establishes a wireless connection with the selected remote by means of the remote's unique identifier, and send a message to the selected remote 30, containing the AED between the base station 32 and the remote 30, and a base station unique identifier. The remote 30 sorts through the list of received base station AED values (received from different base stations 32) to select the base station 32 with the lowest AED to the remote 30. This then confirms the identity association between the specific remote 30 and base station 32, by meeting all the conditions for the identity association. In other words, the driver possessing the selected remote 30 is within the bounds of the driving position and is also closest to the driving position of all candidates (i.e. all other drivers 36 in the vicinity which also operated their remotes 30 at the same time or substantially the same time).

The remote 30 then sends an authentication message containing the remote's unique remote identifier, as well as the base station unique identifier for the particular base station 32, to all nearby base stations 32 which are in range. The base station 32 then checks to see if the received base station unique identifier matches its own unique identifier, and if so, utilises the unique identifier of the remote 30 in order to allow certain operations to be performed which are specifically enabled by the identity association. For example, the base station 32 checks whether the driver 36 is allowed to operate the vehicle 34, and if so, enables the driver 36 to operate the vehicle. It also associates a current operating period of the vehicle 34 with the driver 36 and links any data and events to the driver 36 on the fleet management software.

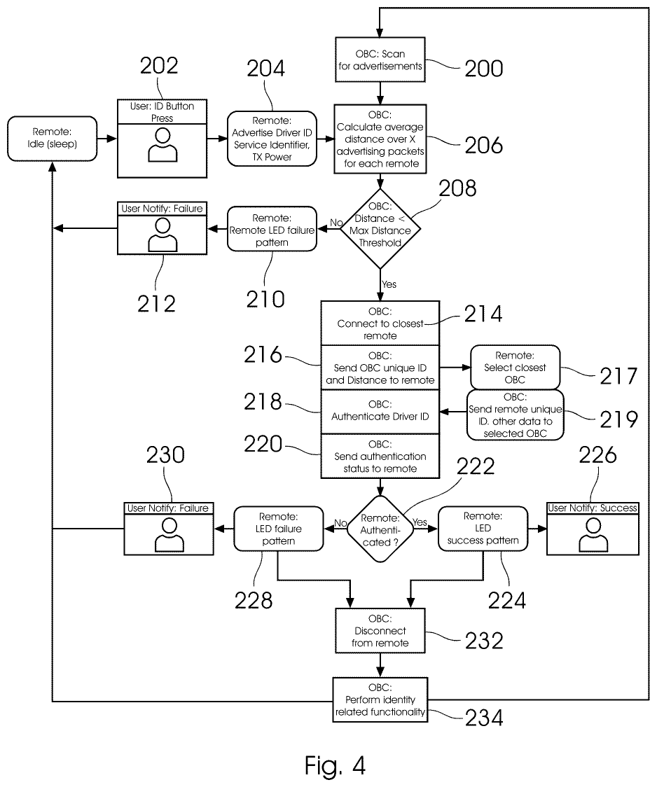

FIG. 4 illustrates the general operation of the present invention in a flow diagram. In summary, a base station/node (indicated in FIG. 4 as “OBC” (On-Board Computer)) scans for signals (also referred to as “Advertisements”) sent from remotes (at block 200). When a user presses an identification button (at block 202) on his/her remote, the remote transmits its service identifier (also referred to as the “Driver ID Service Identifier” or the unique remote identifier) and the transmitted power (TX) via a wireless communication means (at block 204). It should be noted that “Advertising” in this context refers to a mechanism whereby a BLE device sends out a periodic broadcast. This broadcast contains the transmission power, and when received by a “scanning” device (e.g. a base station 32), will result in a “received signal strength” value. The distance calculation is performed using these two values a number of times, and the final result chosen is an average value of the many transmissions. This is to reduce susceptibility to a spike in RSSI.

A base station which is in range receives the “Advertisements” and then calculates an average distance over X packets for each remote (at block 206). If the calculated distance exceeds a maximum distance threshold (at block 208), then a message is transmitted back to the remote in order to indicate that the association has failed. The remote then utilises its status indicating LED's in order to indicate the association failure (at block 210) to a user. If the calculated distance does not exceed the maximum distance threshold (at block 208), then the base station selects and connects to the closest remote (at block 214) and sends the relevant information thereto (as described earlier in the patent specification) (at block 216). The remote then selects the closest base station (as described earlier in the patent specification) (at block 217) and sends the relevant information back to the base station (as described earlier in the patent specification) (at block 219). The base station then sends an authentication status to the remote (at block 220).

If the remote is authenticated/associated (at block 222) then the status indicating LED's of the remote are used in order to indicate that the association has been successful (at block 224), thereby notifying the user (at block 226). If the remote is however not authenticated/associated (at block 222) then the status indicating LED's are used in order to signal that the association has been unsuccessful (at block 228), thereby notifying the user (at block 230).

When this is done, the base station disconnects from the remote (at block 232) and the base station then performs identity related functions (i.e. only functions allowed after identity association has been established), as required (e.g. by allowing the user to operate a vehicle or device) (at block 234).

FIGS. 5a and 5b illustrate the process flow for a base station and a remote, respectively.

The Inventors believe that there are significant advantages to using the methodology described above for identity association, when compared to existing methods, which are described below.

One advantage arising from this wireless means of identity association is the removal of the requirement for an additional physical single purpose receptacle or extension device to enable identity association. This allows for a reduction in the number of components of the identification system which reduces installation complexity, maintenance, and cost. It can also reduce the harmful effects of installation of an identification system on the target apparatus, as the installation of the receptacle device requires modifications that can cause damage to the apparatus. It can also reduce wear on components more than that of the existing near-field methods, as there is no physical or close proximity connection required between devices, which typically induces wear. It also enables improved accessibility of identification capability, such as the case where the addition of a receptacle is not possible due to physical and environmental constraints.

Another advantage is the removal of the requirement for physical or near-field wireless connection of the identification device and identifying system. This enables the ability to perform identity association at a further distance between the agents, where physical and environmental constraints prohibit physical or near-field wireless interaction.

Another advantage is that a standard wireless technology that contains the required properties, such as Bluetooth, can be used as the medium of identity association. This allows more value to be derived from the components of the system, as the standard wireless technology can be a feature of existing parts of the system and used for other purposes, thereby reducing cost and complexity of the overall system. Additionally, using a standard wireless technology provides the ability to add identification capabilities to an existing system through software updates. Rather than requiring the addition of an identification device and receptacle, only the identification device and a software update to the base station are required. An even further reduction in components can be achieved by extending an existing subject device containing a standard wireless technology, such as a smartphone, with the properties of an identification device. This requires only software updates to the existing identification device and existing base station supporting the standard wireless technology to add identification capabilities to the system.

Another advantage is that it improves the ease of use of the identification system. In the automatic mode, where no event is required to signal the intent to identify, no additional action is required for the identity association to take place. This removes several steps from the identity association process, improving ease of use, efficiency, and speed. An example of this could be a person wanting to withdraw money from their bank account at an automated teller machine (ATM) without the need for an additional device such as a bank card. They would simply need to walk within range of the ATM with the identification device on their person, and the system would automatically perform the process of identity association and authentication.

1. A method of performing identity association between a subject and a system, wherein the method includes:
at the system, receiving data via wireless signals from two or more mobile communication devices, wherein each mobile communication device is associated with a specific subject;
at the system, identifying, by using a processor, a specific mobile communication device from the two or more mobile communication devices based on one or more criterion/criteria;
from the system, transmitting data, via wireless communication, to the identified mobile communication device, wherein the data includes a unique identifier for the system (hereinafter referred to as the “system unique identifier”);
at the system, receiving a message from the identified mobile communication device, via wireless communication, wherein the message includes
a unique identifier for the identified mobile communication device, and
an identifier which identifies a specific system;
at the system, comparing, by using a processor, the received identifier which identifies a specific system with the system unique identifier, and if they match, associating the subject, with which the identified mobile communication device is associated, with the system.

2. The method of claim 1,
wherein the one or more criterion/criteria for identifying the specific mobile communication device from the two or more mobile communication devices includes only taking into account mobile communication devices who's data has been received within a specified/pre-determined time frame or time window.

3. The method of claim 2, wherein the time frame or time window runs from when the system first receives data via a wireless signal from a first of the two or more communication devices.

4. The method of claim 1, which includes enabling one or more functions to be performed by a subject which has been associated with the system, wherein the one or more functions would otherwise not be permitted if the subject was not associated with the system.

5. The method of claim 1, wherein the one or more criterion/criteria for identifying the specific mobile communication device from the two or more mobile communication devices includes taking into account a relative proximity between the system and each of the two or more mobile communication devices with which the respective subjects are associated.

6. The method of claim 5, wherein
the method includes determining or obtaining, by using a processor, an indication of an approximate distance between the system and each mobile communication device, by utilising a signal strength of the received signal from each mobile communication device,
the one or more criterion/criteria for identifying the specific mobile communication device from the two or more mobile communication includes determining/identifying the mobile communication device which is the closest to the system.

7. The method of claim 6, which includes sending, from the system, (i) an indication of the approximate distance determined between the system and the closest mobile communication device, and (ii) the system unique identifier for the system, back to the identified mobile communication device which is closest to the system, via wireless communication.

8. The method of claim 1 wherein the data received from each mobile communication device includes any one or more of the following:
a relative heading/direction and speed of travel of the particular mobile communication device;
a relative acceleration of the particular mobile communication device;
a relative position of the particular mobile communication device;
a temperature associated with the particular mobile communication device; and
a humidity associated with the particular mobile communication device.

9. A system for performing identity association with a subject, wherein the system includes:
a communication module which is configured to receive wireless signals which are transmitted from two or more mobile communication devices, wherein each mobile communication device is associated with a particular subject; and
an association module which is configured to
identify a specific mobile communication device from the two or more mobile communication devices based on one or more criterion/criteria
transmit data, via wireless communication, to the identified mobile communication device, wherein the data includes a unique identifier for the system (hereinafter referred to as the “system unique identifier”),
receive a message from the identified mobile communication device, via wireless communication, wherein the message includes
a unique identifier for the identified mobile communication device, and
an identifier which identifies a specific system, and
compare the received identifier which identifies a specific system with the system unique identifier, and if they match, associating the subject, with which the identified mobile communication device is associated, with the system.

10. The system of claim 9, wherein the one or more criterion/criteria for identifying the specific mobile communication device from the two or more mobile communication devices includes only
taking into account mobile communication devices whose data has been received within a specified/pre-determined time frame or time window.

11. The system of claim 10, wherein the time frame or time window runs from when the communication module first receives data via a wireless signal from a first of the two or more communication devices.

12. The system of claim 9, wherein the association module is configured to enable one or more functions to be performed by a subject which is associated with the system, whereby the one or more functions would otherwise not be permitted if the subject was not associated with the system.

13. The system of claim 9, wherein the one or more criterion/criteria for identifying the specific mobile communication device from the two or more mobile communication devices includes taking into account a relative proximity between the system and each of the two or more mobile communication devices, in order to determine which subject should be associated with the system.

14. The system of claim 13, wherein
the system includes a calculation module which is configured to determine or obtain an indication of an approximate distance between the system and each mobile communication device, by utilising a signal strength of the received signal from each mobile communication device,
the one or more criterion/criteria for identifying the specific mobile communication device from the two or more mobile communication devices includes identifying the mobile communication device which is the closest to the system.

15. The system of claim 9, wherein the two or more mobile communication devices form part of the system.

16. The system of claim 9 wherein data received from each mobile communication device includes any one or more of the following:
a relative heading/direction and speed of travel of the particular mobile communication device;
a relative acceleration of the particular mobile communication device;
a relative position of the particular mobile communication device;
a temperature associated with the particular mobile communication device; and
a humidity associated with the particular mobile communication device.

17. A method of performing identity association between a subject and a system, wherein the method includes:
from a mobile communication device of the subject, transmitting a wireless signal which includes an identifier which identifies the specific subject or mobile communication device (hereinafter referred to as the “device identifier”);
receiving, via wireless communication at the mobile communication device, a message from each of a plurality of systems, wherein each message includes
an identifier which identifies the particular system (hereinafter referred to as the “system identifier”),
an identifier which identifies a specific subject or mobile communication device (hereinafter referred to as the “first identifier”), and
additional data,
for each of the plurality of systems, identifying if the first identifier included in the received message from the specific system, matches the device identifier of the specific subject/mobile communication device,
identifying a specific system, from those systems whose message included a first identifier which matched the device identifier of the specific subject/mobile communication device, with which the subject should be associated, based on one or more criterion/criteria.

18. The method of claim 17, which includes transmitting, via wireless communication from the mobile communication device, a message which includes the system identifier of the system with which the subject should be associated.

19. The method of claim 17,
wherein the additional data includes an indication of the approximate distance between the particular system and the mobile communication device;
wherein the one or more criterion/criteria includes identifying which specific system, from those systems whose message included a first identifier which matched the device identifier of the specific subject/mobile communication device, is the nearest to the mobile communication device, by utilising the indications of the approximate distances between the mobile communication device and each of the said systems, and selecting the identified system to be associated with the subject; and
wherein the method includes transmitting, via wireless communication from the mobile communication device, a message which includes the system identifier of the system with which the subject should be associated.

20. The method of claim 17, wherein the additional data includes any one or more of the following:
a relative heading/direction and speed of travel of the particular system;
a relative acceleration of the particular system;
a relative position of the particular system;
a temperature associated with the particular system;
a humidity associated with the particular system.

21. A mobile communication device on which a set of instructions are stored which, when executed by a processor of the device, performs method as claimed in claim 17.

22. A non-transitory computer readable storage medium on which a set of instructions are stored which, when executed, performs the method as claimed in claim 1.

23. A non-transitory computer readable storage medium on which a set of instructions are stored which, when executed, performs the method as claimed in claim 17.

24. A method of performing identity association between multiple subjects which each have a mobile communication device and multiple systems, wherein the method includes:
at each system, receiving data via wireless signals from two or more mobile communication devices, wherein each mobile communication device is associated with a specific subject, and wherein the data from each mobile communication device includes at least an identifier (hereinafter referred to as the “device identifier”) which identifies the particular mobile communication device;
at each system, identifying, by using a processor, a specific mobile communication device from the two or more mobile communication devices based on one or more criterion/criteria;
from each system, transmitting data via a wireless signal(s), wherein the data includes a unique identifier for the system (hereinafter referred to as the “system unique identifier”) and the device identifier of the mobile communication device identified by the particular system;
at each mobile communication device:
receiving, via wireless communication, data from each of a plurality of systems, wherein the data includes
an identifier which identifies the particular system,
an identifier (hereinafter referred to as the “first identifier”) which identifies a specific mobile communication device, and
additional data,
for each of the plurality of systems, identifying if the first identifier included in the received data from the specific system, matches the device identifier of the specific mobile communication device,
identifying one specific system, from those systems whose data included a first identifier which matched the device identifier of the specific mobile communication device, with which the subject should be associated, based on one or more criterion/criteria.

25. A system for performing identity association between multiple systems and multiple mobile communication devices, wherein each mobile communication device is associated with a specific subject, wherein the system includes:
a plurality of systems which are each as claimed in claim 9; and
a plurality of mobile communication devices which are each as claimed in claim 21.
